(19) United States
(12) Patent Application Publication
(10) Pub. No.: US 2006/0130096 A1
(43) Pub. Date: Jun. 15, 2006

(54) Information processing apparatus, information processing method, and computer program

(76) Inventors: Shunsuke Aoki, Kanagawa (JP); Tomoyuki Yamamoto, Kanagawa (JP); Kazuhito Sumiyoshi, Tokyo (JP); Setsushi Minami, Tokyo (JP); Jun Kaneko, Kanagawa (JP)

Correspondence Address: BELL, BOYD & LLOYD, LLC, P. O. BOX 1135, CHICAGO, IL, 60690-1135, US

(21) Appl. No.: 11/205,971

(22) Filed: Aug. 17, 2005

(30) Foreign Application Priority Data
Aug. 20, 2004 (JP) P2004-241275

(51) Int. Cl. H04N 5/445; H04H 9/00; H04N 7/16; G06F 13/00; G06F 3/00

(52) U.S. Cl. 725/46; 725/13; 725/9; 725/44

(57) ABSTRACT

An information processing apparatus, information processing method, and computer program are provided. The information processing apparatus includes an obtaining device for obtaining program information of a program; a number conversion device for converting the program information into a numerical value; an evaluation device for evaluating the program on the basis of the numerical value obtained by the number conversion by the number conversion device; a graphic representation device for collectively converting the evaluation results by the evaluation device into graphical representation; and a presentation device for presenting the evaluation results that are graphically represented by the graphic representation device.

### CROSS REFERENCES TO RELATED APPLICATIONS

The present application claims priority to Japanese Patent Application No. 2004-241275 filed in the Japan Patent Office on Aug. 20, 2004, the entire contents of which being incorporated herein by reference.

### BACKGROUND

The present invention relates to an information processing apparatus, an information processing method, and a computer program. More particularly, the present invention relates to an information processing apparatus capable of providing information that is most appropriate for a program selection by a user, an information processing method for use therewith, and a computer program for use therewith.

As digital terrestrial broadcasting has started and hard disk recording has become highly functional, the chances of viewing a television broadcast program has greatly increased. As a result, while the user has become able to view various programs, the user needs to select a program desired to be viewed from an enormous selection of viewable programs.

Therefore, a method for providing the degree of interest (Japanese Unexamined Patent Application Publication No. 2002-279026) of the viewer with respect to the program as determination material for the user to select the program on the basis of the audience rating (Japanese Unexamined Patent Application Publication No. 09-261609) and the description for the program, which is transmitted from, for example, viewers in the Internet, has been proposed.

However, in the related art, determination materials for the audience rating and the degree of interest are provided individually. Therefore, it is not easy to select a program by comprehensively using the plurality of those determination materials.

### SUMMARY

The present invention has been made in view of such circumstances. It is desirable to provide determination materials so that a plurality of determination materials can be used comprehensively.

According to an embodiment, there is provided an information processing apparatus including: obtaining means for obtaining program information of a program; number conversion means for converting the program information into a numerical value; evaluation means for evaluating the program on the basis of the numerical value obtained by the number conversion by the number conversion means; graphic representation means for collectively converting the evaluation results by the evaluation means into graphical representation; and presentation means for presenting the evaluation results that are graphically represented by the graphic representation means.

The program information may contain predetermined elements. The number conversion means may perform a number conversion for each element. The evaluation means may evaluate a program on the basis of the numerical value of the predetermined element, which is obtained as a result of the number conversion by the number conversion means.

The obtaining means may obtain the audience rating of a predetermined program, a program description, a keyword, information about a broadcast time, information about a performer of the program, impressions of programs that are sent to the program introduction site and the number of the impressions, the number of reuse of the program introduction information, the number of comments that are sent to the official site of the program, and the usage history of the program of a predetermined terminal. The number conversion means may set the program description and the impressions sent to the program introduction site as a first element; sets the keyword as a second element; sets the information about the broadcast time as a third element; sets the number of impressions of the program, which are sent to the program introduction site, and the number of comments sent to the program official site, as a fourth element; sets the number of reuse of the program introduction information as a fifth element; sets the audience rating and the usage history as a sixth element; and sets the information about the performer of the program as a seventh element, and may perform number conversion for each of the first to seventh elements.

The evaluation means may compute the evaluation value of the program on the basis of the numerical values of the first, second, fourth, fifth, and sixth elements; on the basis of the numerical value of the third element; on the basis of the numerical values of the first and second elements; on the basis of the numerical value of the first element; on the basis of the numerical values of the first and third elements; and on the basis of the numerical value of the sixth element.

The program may be a program that is broadcast in series. The number conversion means may convert each piece of the program information of the program that is broadcast in series into a numerical value. The evaluation means may evaluate each of the programs broadcast in series on the basis of the numerical value obtained by the number conversion by the number conversion means. The graphic representation means may arrange the evaluation values obtained as a result of the evaluation by the evaluation means in a time series so as to convert the evaluation results into graphic representation.

According to another embodiment, there is provided an information processing method including the steps of: obtaining program information of a program; converting the program information into a numerical value; evaluating the program on the basis of the numerical value obtained by the number conversion in the number conversion step; collectively converting the evaluation results in the evaluation step into graphic representation; and presenting the evaluation results that are graphically represented in the graphic representation step.

According to another embodiment, there is provided a computer program including the steps of: obtaining program information of a program; converting the program information into a numerical value; evaluating the program on the basis of the numerical value obtained by the number conversion in the number conversion step; collectively converting the evaluation results in the evaluation step into graphic representation; and presenting the evaluation results that are graphically represented in the graphic representation step.

In the information processing apparatus, the information processing method, and the computer program in accordance with the embodiments of the present invention, program information of a program is obtained, the program information is converted into a numerical value, the program is evaluated on the basis of the numerical value obtained by the number conversion, the evaluation results are collectively converted into graphic representation, and the graphically represented evaluation results are presented.

According to an embodiment, the selection of a program can be made easily.

Additional features and advantages are described herein, and will be apparent from, the following Detailed Description and the figures.

### BRIEF DESCRIPTION OF THE FIGURES

FIG. 1 shows an example of usage of a terminal to which the present invention is applied.

FIG. 2 shows an example of an input screen used when program introduction information is input.

FIG. 3 shows an example of a program introduction screen.

FIG. 4 is a block diagram showing an example of the configuration of the terminal of FIG. 1.

FIG. 5 is a block diagram showing an example of the functional configuration of the terminal of FIG. 1.

FIG. 6 shows the relationship between information analyzed by an analysis section of FIG. 5 and an analysis value used by an evaluation section.

FIG. 7 is a view showing evaluation results.

FIG. 8 is another view showing evaluation results.

FIG. 9 shows an example of obtained program information.

FIG. 10 shows a table for converting information related to broadcast times into numerical values.

FIG. 11 shows another table for converting information related to broadcast times into numerical values.

FIG. 12 shows another table for converting information related to broadcast times into numerical values.

FIG. 13 is another view showing evaluation results.

FIG. 14 is another view showing evaluation results.

FIG. 15 shows another example of obtained program information.

FIG. 16 is another view showing evaluation results.

### DETAILED DESCRIPTION

The present invention relates to an information processing apparatus, an information processing method, and a computer program. More particularly, the present invention relates to an information processing apparatus capable of providing information that is most appropriate for a program selection by a user, an information processing method for use therewith, and a computer program for use therewith.

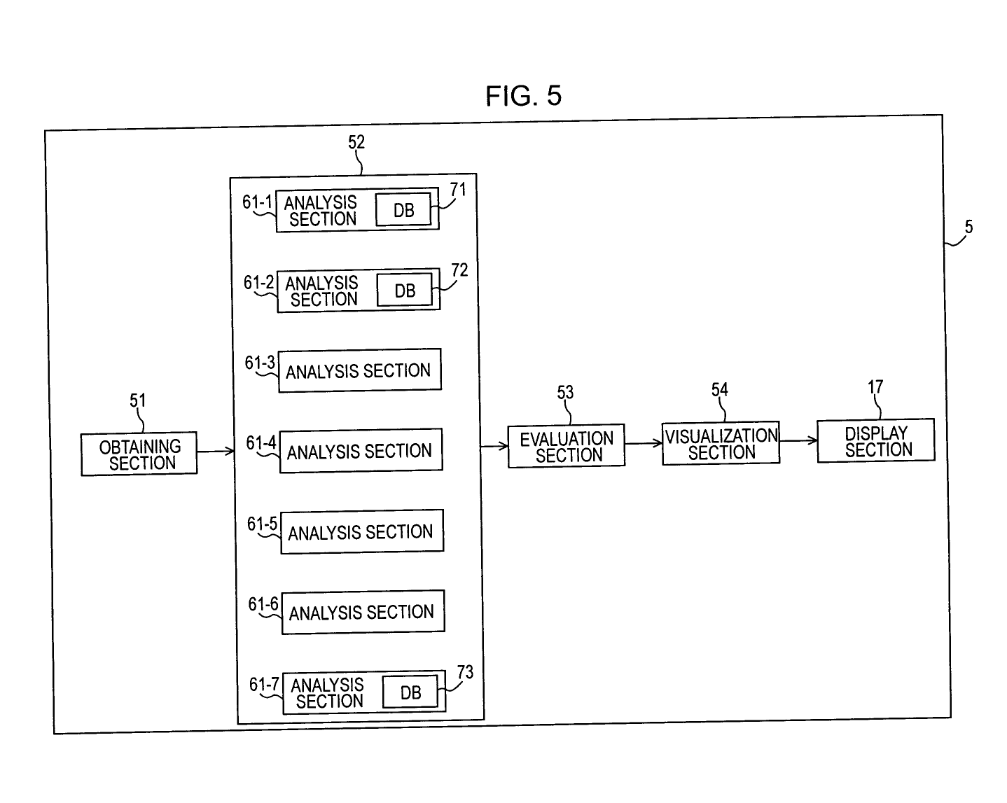

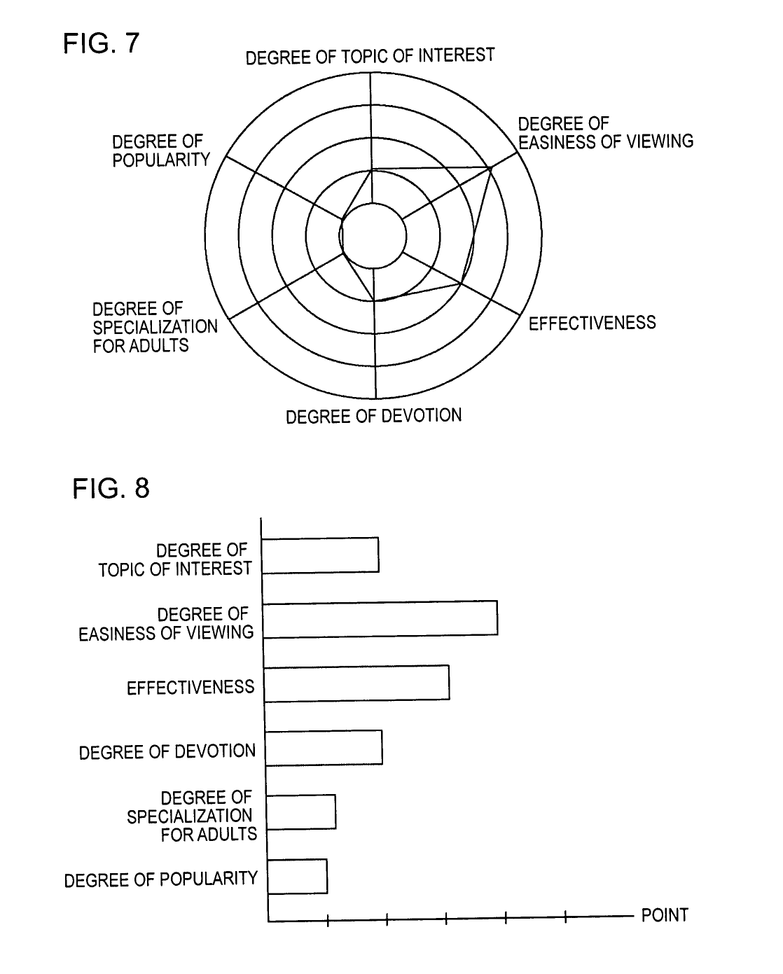

An information processing apparatus according to an embodiment of the present invention includes obtaining means (for example, an obtaining section 51 of FIG. 5) for obtaining program information of a program, number conversion means (for example, an analysis section 52 of FIG. 5) for converting program information into a numerical value, evaluation means (for example, an evaluation section 53 of FIG. 5) for evaluating a program, graphic representation means (for example, a visualization section 54 of FIG. 5) for collectively converting evaluation results by the evaluation means into graphic representation, and presentation means (for example, a display section 17 of FIG. 5) for presenting the evaluation results (for example, FIGS. 7, 8, 13, and 14) that are graphically represented by the graphic representation means.

The program information is formed of predetermined elements. The number conversion means performs number conversion for each element. The evaluation means can evaluate the program on the basis of the numerical values of predetermined elements, which are obtained as a result of the number conversion by the number conversion means.

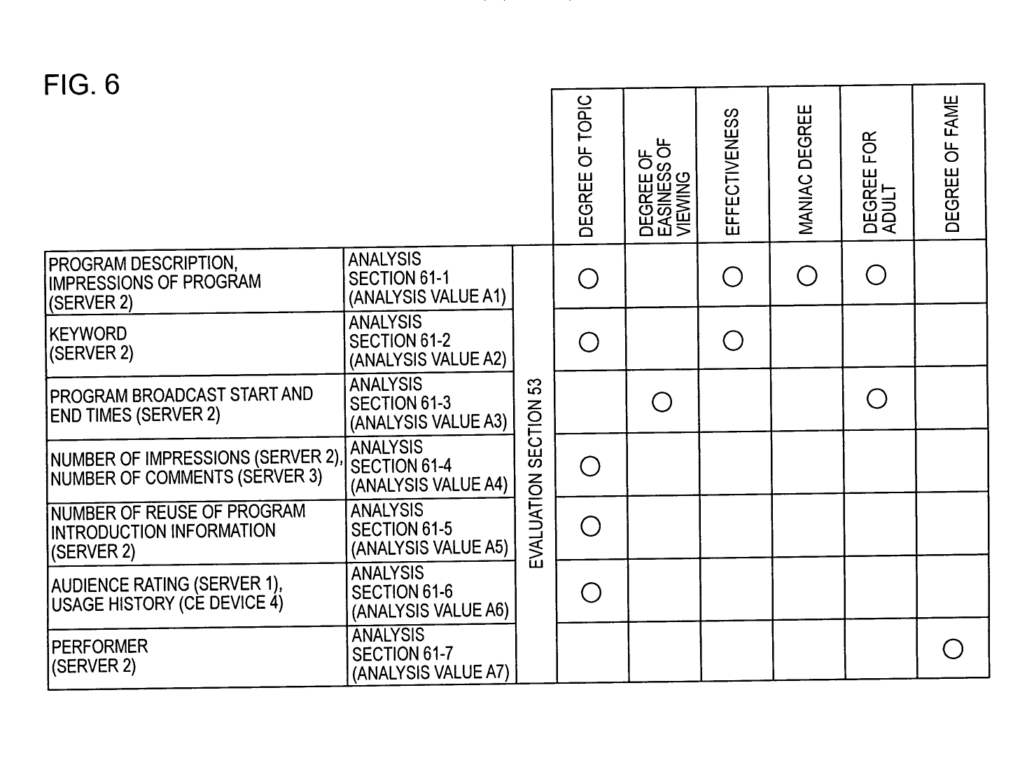

The obtaining means obtains the audience rating of a predetermined program, the program description, the keyword, information about the broadcast time, information about the performer for the program, the impressions of the program, which are sent to the program introduction site and the number thereof, the number of reuse of the program introduction information, the number of comments sent to the official site of the program, and the usage history of the program of a predetermined terminal. The number conversion means sets the program description and the impressions sent to the program introduction site as a first element; sets the keyword as a second element; sets information about the broadcast time as a third element; sets the number of impressions sent to the program introduction site and the number of comments sent to the program official site as a fourth element; sets the number of reuse of the program introduction information as a fifth element; sets the audience rating and the usage history as a sixth element; and sets information about the performer of the program as a seventh element, and can perform number conversion for each of the first to seventh elements (for example, FIG. 6).

The evaluation means can compute the evaluation value of the program, for example, can compute the degree of topic of interest on the basis of the numerical values of the first, second, fourth, fifth and sixth elements, the degree of easiness of viewing on the basis of the numerical values of the third element, the degree of effectiveness on the basis of the numerical values of the first and second elements, the degree of devotion on the basis of the numerical values of the first and second elements, the degree of specialization for adults on the basis of the numerical values of the first and third elements, and the degree of popularity on the basis of the numerical values of the sixth element (for example, FIG. 6).

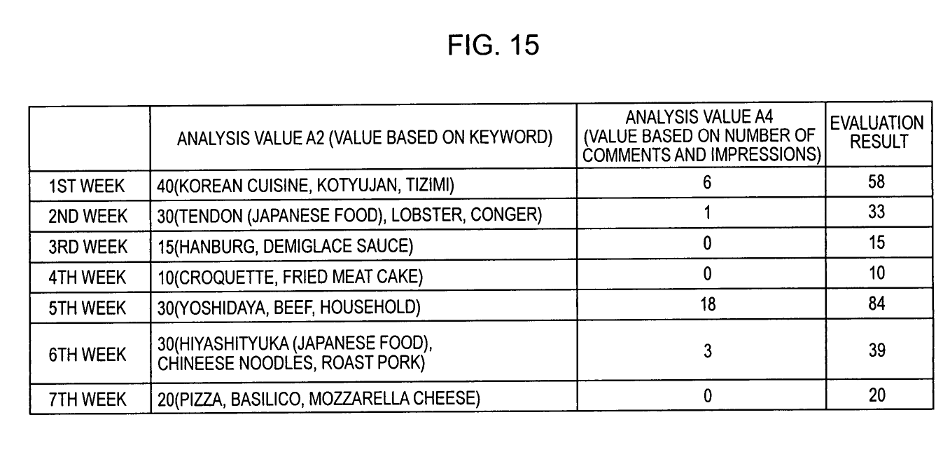

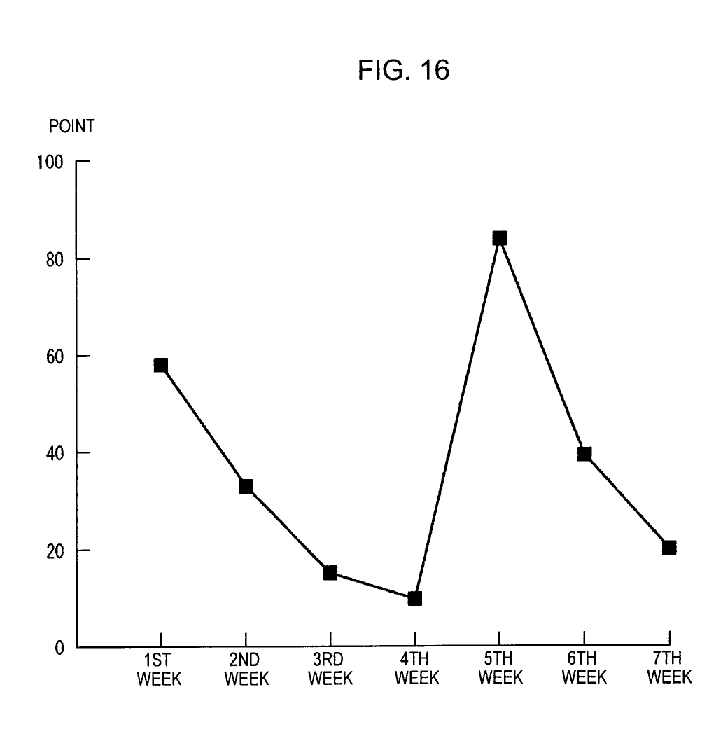

When the program is a program broadcast in series, the number conversion means converts the program information of the program broadcast in series into a numerical value (for example, FIG. 15). The evaluation means evaluates each of the programs broadcast in series on the basis of the numerical value obtained by the number conversion by the number conversion means (for example, FIG. 15). The graphic representation means can arrange the evaluation values obtained as a result of the evaluation results by the evaluation means so as to convert the evaluation results into graphic representation (for example, FIG. 16).

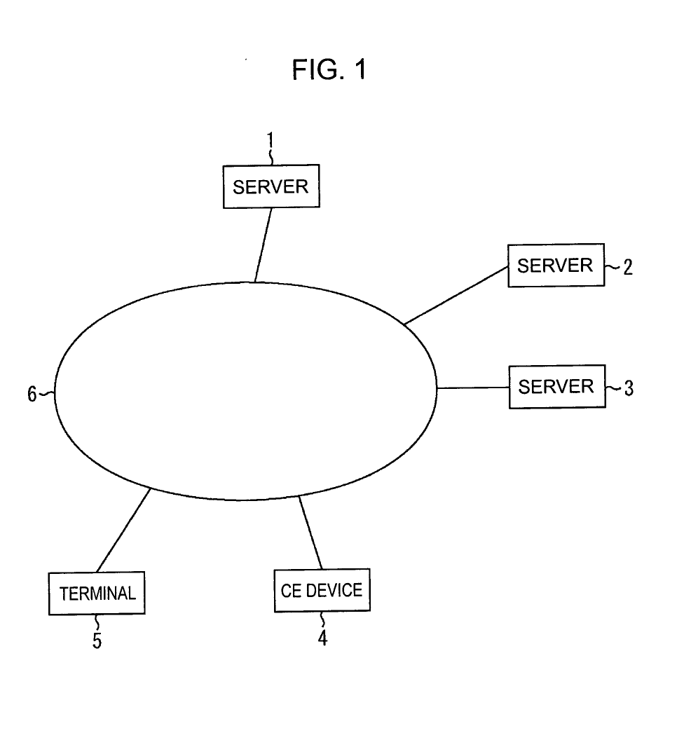

FIG. 1 shows an example of the usage of a terminal 5 to which the present invention is applied.

A server 1 adds up the audience rating of the program that is broadcast by television, and supplies it to the terminal 5 via a network 6 in response to a request.

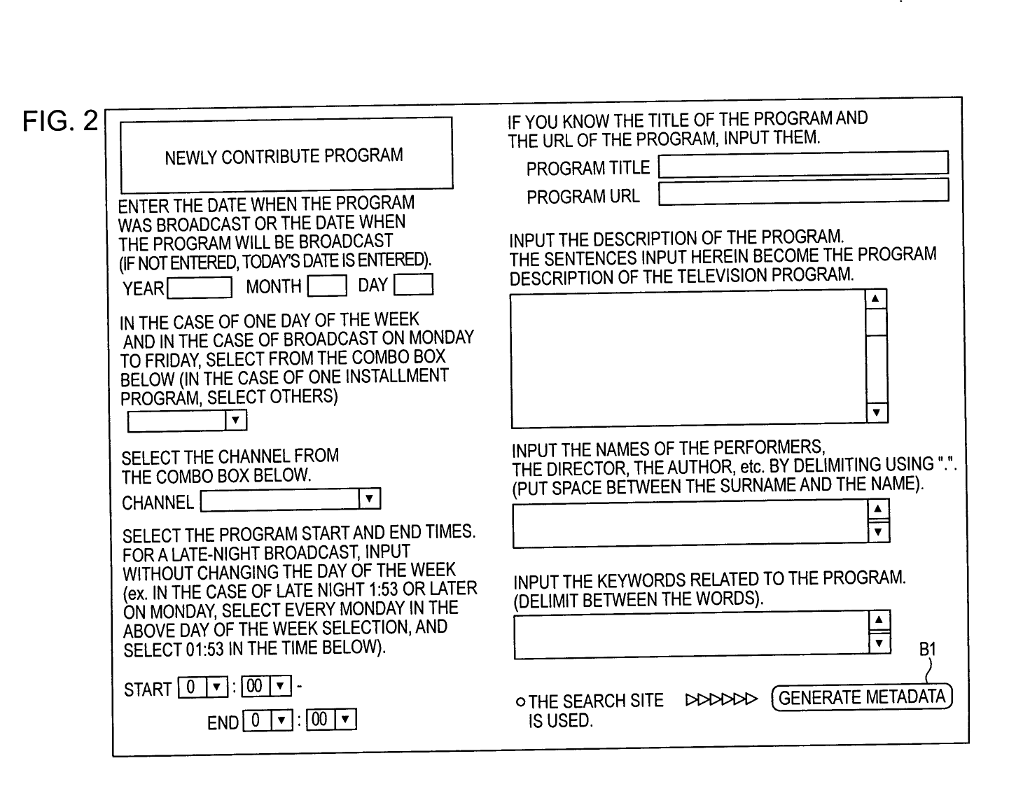

A server 2 has set up a home page for introducing a television broadcast program in the network 6. In this page, a description tool that uses an input screen shown in FIG. 2 is used to introduce input information and the like.

This input screen enables information, such as the broadcast day, the week of the broadcast day, the broadcast start and end times, the title, the URL of the program, the program description, the performer, the keyword, and the like (hereinafter, when these need not to be distinguished individually, these pieces of the information are referred to as “program introduction information”) to be input.

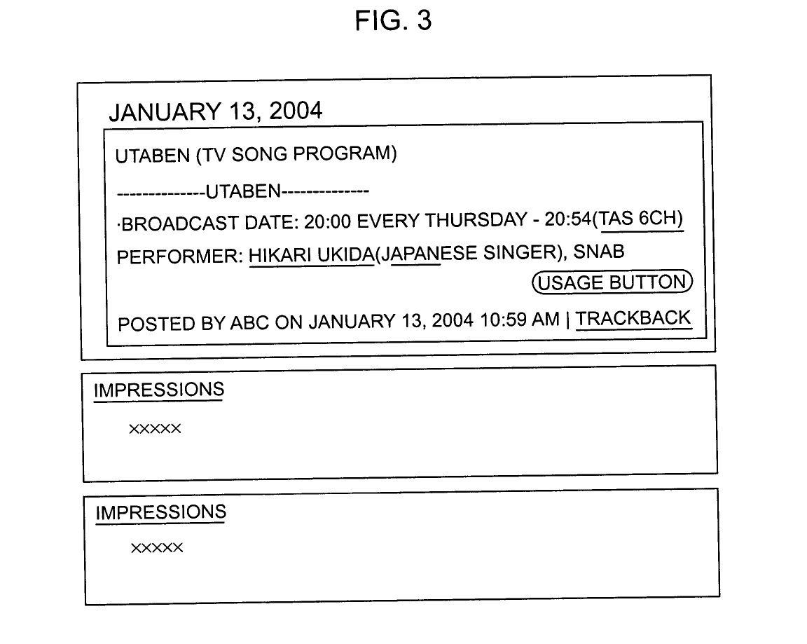

FIG. 3 shows an example of the program introduction screen presented by the server 2. In this example, the title, the broadcast day, the week of the broadcast day, the broadcast start and end times, the broadcast station, and the performer, and the impressions of the program, which were separately sent to the server 2, are displayed.

In the description tool used in the server 2, if a button B1 is operated after the program introduction information (FIG. 2) is input to the input screen, the input information is stored as metadata in the server 2. For example, in the case where this program is broadcast every week, when the program introduction information for the program to be broadcast for the next week is input, the information, stored as metadata, that was broadcast in the previous week, can be used. That is, the program introduction information is reused.

Referring back to FIG. 1, in response to a request, the server 2 supplies, to the terminal 5 via the network 6, the program introduction information of a predetermined program, the impressions of the program, which were sent to the server 2, the number thereof, and the number of reuse of the program introduction information.

The server 3 has set up a home page as an official site of a predetermined program (for example, program P1) in the network 6. In this home page, detailed information about the program P1 is presented. This server 3, in response to a request, supplies the number of comments of the program, which were accepted via this official site, to the terminal 5.

A CE device 4 is used by, for example, a user of the terminal 5. The CE device 4 plays back and records a program specified by the user, stores the viewed and recorded history (hereinafter, referred to as “usage history”), and supplies it to the terminal 5 via the network 6 in response to a request.

The terminal 5 communicates with the server 1 through the CE device 4 via the network 6. The terminal 5 obtains therefrom, the “audience rating of the broadcast program”, the “program introduction information”, the “impressions of the program, which were sent to the server 2”, the “number thereof”, the “number of times in which the program introduction information was reused”, the “number of comments sent to the official site”, and the “usage history” (hereinafter, when these need not to be distinguished individually, these will be referred to simply as “program information”), converts the obtained pieces of the information into numerical values in order to evaluate the program, and collectively converts the evaluation results into graphic representation and display it.

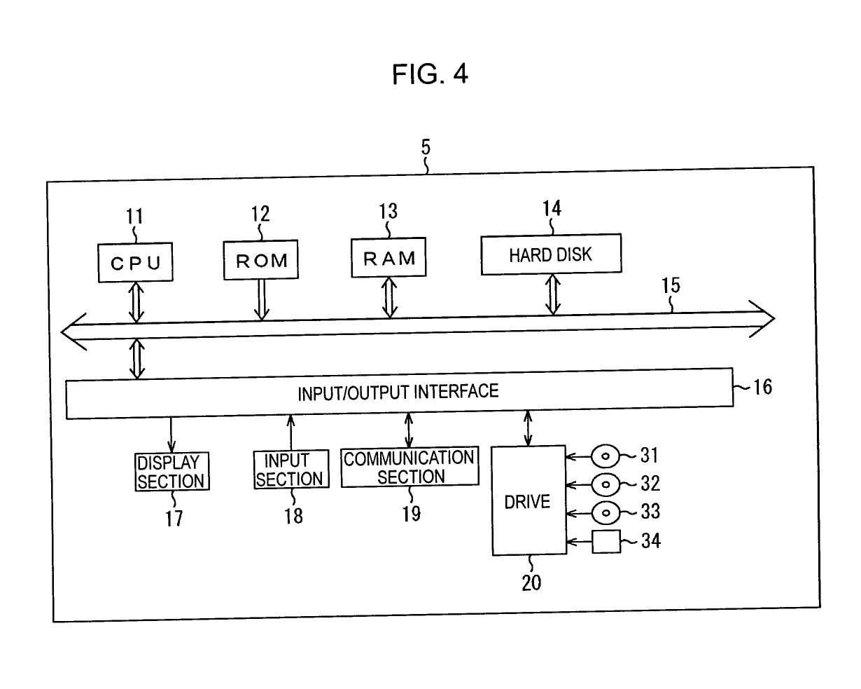

FIG. 4 shows an example of the configuration of the terminal 5. An input/output interface 16 is connected to a CPU (Central Processing Unit) 11 via a bus 15. When an instruction is input from an input section 18 including a keyboard, a mouse, etc., by the user via the input/output interface 16, the CPU 11 loads, into a RAM (random access memory) 13, a program stored in a recording medium, such as a hard disk 14 or a magnetic disk 31, an optical disc 32, a magneto-optical disc 33, or a semiconductor memory 34, which is loaded into a drive 20, and executes the program. Furthermore, the CPU 11 outputs the processing results to, for example, a display section 17 including an LCD (Liquid Crystal Display) as necessary via the input/output interface 16. The program can be stored in advance in the hard disk 14 and the ROM 12, so that the program is provided to the user integrally with the terminal 5, or is provided as a packaged medium, such as the magnetic disk 31, the optical disc 32, the magneto-optical disc 33, or the semiconductor memory 34, or is provided to the hard disk 14 from an satellite, a network, etc., via a communication section 19.

FIG. 5 is a block diagram showing an example of the functional configuration of the terminal 5.

The obtaining section 51 (formed of, for example, the CPU 11 through the RAM 13, and the communication section 19) communicates with the server 1 through the CE device 4 via the network 6 in order to obtain the “audience rating” of a predetermined program (in the case of this program, denoted as a program P1) from the server 1; obtain, from the server 2, the “program introduction information” of the program P1, the “impressions” of the program P1, which were sent to the server 2, the “number thereof” and the “number of reuse of the “program introduction information”; obtain the “number of comments” accepted via the official site of the program P1 from the server 3; and obtain the “usage history” from the CE device 4. That is, the obtaining section 51 obtains the program information. The obtained program information is supplied to an analysis section 52.

The analysis section 52 (formed of, for example, the CPU 11 through the hard disk 14) converts the program information supplied from the obtaining section 51 into numerical values, and supplies the evaluation values A obtained as a result to the evaluation section 53. Here, the details of the analysis section 52 are described.

The analysis section 61 extracts predetermined phrases from the “program description” in the program introduction information (server 2) of the program P1 and the “impressions” (character information) of the program, which are supplied from the obtaining section 51, and performs numerical value analysis on the extracted phrases.

More specifically, the analysis section 61-1 has a thesaurus database (DB) 71 in which words and phrases are classified according to meanings and predetermined numerical values are set for each classification. The analysis section 61-1 detects the numerical values corresponding to the extracted phrases from the thesaurus DB 71 and denotes them as an evaluation value A1.

An analysis section 61-2 performs numerical value analysis on the “keyword” in the program introduction information (server 2) of the program P1, which is supplied from the obtaining section 51.

More specifically, the analysis section 61-2 has a thesaurus DB 72 in which words and phrases that can become keywords are classified according to meanings and a predetermined numerical value is set for each classification. The analysis section 61-2 detects a numerical value corresponding to the “keyword”, which is obtained from the thesaurus DB 72, and denotes it as an evaluation value A2.

An analysis section 61-3 performs numerical value analysis on the “broadcast start time” and “end time” in the program introduction information (server 2) of the program P1, which is supplied from the obtaining section 51.

More specifically, an analysis section 61-3 has a table in which predetermined times (broadcast start and end times), and predetermined numerical values are set for each predetermined time (broadcast time). The analysis section 61-3 detects a numerical value corresponding to the “broadcast start time”, the “end time”, and the “broadcast time”, which are supplied from the obtaining section 51, and denotes them as an evaluation value A3.

An analysis section 61-4 adds up the “number of impressions” (server 2), which were sent to the program introduction site of the program P1, and the “number of comments” (server 3), which were sent to the official site of the program P1, the numbers being supplied from the obtaining section 51, and denotes the value corresponding to the totaled result as an evaluation value A4.

An analysis section 61-5 denotes the value corresponding to the “number of times in which the program introduction information was reused” (server 2) of the program P1, which is supplied from the obtaining section 51, as an evaluation value A5.

An analysis section 61-6 denotes the values corresponding to the “audience rating” (server 1) of the program P1 and the “usage history” (CE device 4) (server 1) of the program P1, which are supplied from the obtaining section 51, as an evaluation value A6.

An analysis section 61-7 converts the “performer” in the program introduction information (server 2) of the program P1, which is supplied from the obtaining section 51, into a numerical value.

More specifically, the analysis section 61-7 has a celebrity database 73 in which a value corresponding to the degree of popularity of an entertainer is set for each of the entertainers. Therefore, the analysis section 61-7 detects, from the database 73, a numerical value corresponding to the performer, and denotes it as an evaluation value A7.

The analysis sections 61-1 to 61-7 supply the evaluation values A1 to A7 obtained as a result of the numerical value analysis to the evaluation section 53. In FIG. 6, what kind of information is analyzed by the analysis section 61 in order to perform number conversion is collectively shown.

Referring back to FIG. 5, the evaluation section 53 (formed of, for example, the CPU 11 through the RAM 13) evaluates predetermined evaluation items of the program (program P1) on the basis of the evaluation values A1 to A7 supplied from the analysis section 52.

In the case of this example, six evaluation items, that is, the “degree of topic of interest”, the “degree of easiness of viewing”, the “degree of effectiveness”, the “degree of devotion”, the “degree of specialization for adults”, and the “degree of casting popularity” are provided. The evaluation values are indicated using five levels of 1 to 5, and this means that the higher the value, the more highly it is evaluated.

As collectively shown in FIG. 6, the “degree of topic of interest” is determined on the basis of the evaluation values A1, A2, A4, A5, and A6 from the respective analysis sections 61-1, 61-2, 61-4, 61-5, and 61-6, and indicates the degree at which the program is talked about.

The “degree of easiness of viewing” is determined on the basis of the evaluation value A3 from the analysis section 61-3, and indicates the degree at which the program is a program that is easy to view from the viewpoint of, for example, the broadcast time of the program.

For example, it is assumed that the programs that are broadcast for 30 minutes from 7:00 p.m. to 7:30 p.m. are easier to view than those that are broadcast for 3 hours from 11:00 p.m. to 2:00 a.m.

The “degree of effectiveness” is determined on the basis of the evaluation values A1 to A2 from the analysis section 61-1 to 61-2, and indicates the degree at which the program is effective from the viewpoint of education.

The “degree of devotion” is determined on the basis of the evaluation value A1 from the analysis section 61-1, and indicates the degree at which the program is specialized for a specific hobby.

The “degree of specialization for adults” is determined on the basis of the evaluation values A1 and A3 from the analysis sections 61-1 and 61-3, and indicates the degree at which the program is specialized for adults.

The “degree of casting popularity” is determined on the basis of the evaluation value A7 from the analysis section 61-7, and indicates the degree of popularity of the performer.

The evaluation section 53 supplies the evaluation value of each evaluation item, which is obtained as a result of the evaluation, to the visualization section 54.

The visualization section 54 converts the above-described six evaluation values supplied from the evaluation section 53 into graphic representation, as shown in, for example, FIGS. 7 or 8, and outputs and displays the evaluation values on the display section 17.

As described above, the program information is converted into numerical values, and based on the numerical value obtained thereby, the program is evaluated with respect to predetermined items. A1 so, the evaluation results are converted into graphic representation and presented to the user. Thus, it is possible for the user to select a program by comprehensively using the plurality of evaluation results. Since the program evaluation performed herein is based on typical reference (since the system does not determine on its own the preference of the user in order to perform an evaluation), it is possible for the user to subjectively use the evaluation results and select a program desired by the user.

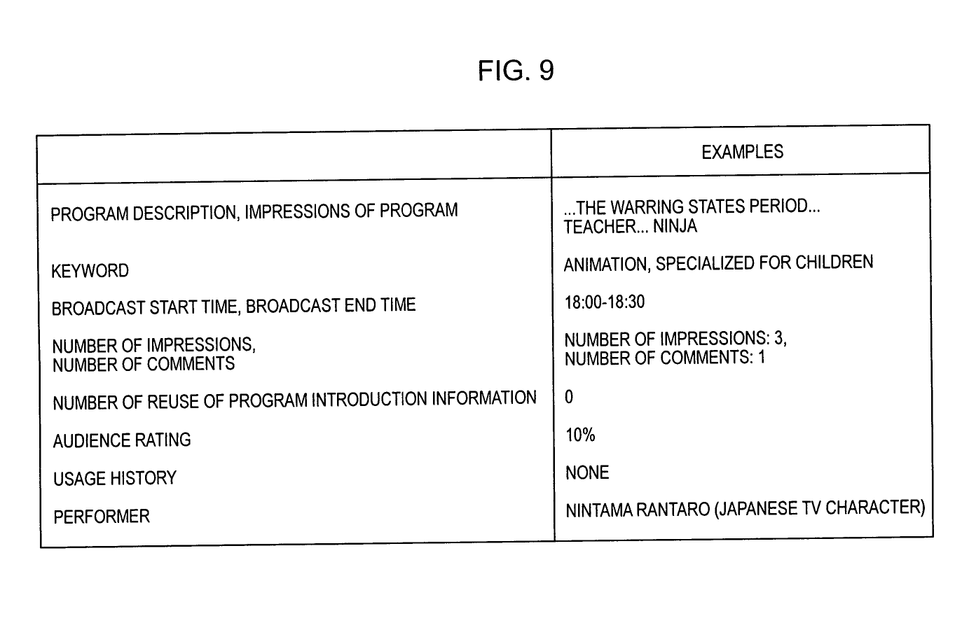

Next, the operation of the analysis section 52 through the visualization section 54 is described by using as an example a case in which the program information of the program P1, shown in FIG. 9, is obtained by the obtaining section 51.

The analysis section 61-1 of the analysis section 52 decomposes the “program description” and the “impressions of the program” of the program introduction information of the program P1, which is supplied from the obtaining section 51, into phrase units in order to obtain the phrases of the “Warring States period”, the “teacher”, and the “Ninja”.

The analysis section 61-1 obtains the evaluation value A1 from the numerical values of the “Warring States period”, the “teacher”, and the “Ninja”, which are defined in the thesaurus DB 71.

The evaluation value A1 obtained by the analysis section 61-1 is used for the evaluation in the evaluation items of the “degree of topic of interest”, the “degree of effectiveness”, the “degree of devotion”, and the “degree of specialization for adults” as shown in FIG. 6 (when FIG. 6 is seen laterally). Therefore, numerical values of phrases are set for each of those evaluation items in the thesaurus DB 71.

As a result, in the case of this example, the evaluation value A1 with respect to the “Warring States period”, the “teacher”, and the “Ninja” becomes 0 points in the evaluation item of the “degree of topic of interest”, 20 points in the evaluation item of the “degree of effectiveness”, 40 points in the evaluation item of the “degree of devotion”, and 5 points in the evaluation item of the “degree of specialization for adults”.

The analysis section 61-2 obtains the “animation” and the “specialized for children”, which are keywords in the program introduction information of the P1 supplied from the obtaining section 51. Then, the analysis section 61-2 obtains the evaluation value A2 from the numerical values of the “animation” and the “specialized for children”, which are defined in thesaurus DB 72.

The evaluation value A2 obtained by the analysis section 61-2 is used for the evaluation in the evaluation items “degree of topic of interest” and the “degree of effectiveness”, as shown in FIG. 6. Therefore, in the thesaurus DB 72, the numerical value of the keyword is set for each of the those evaluation items.

As a result, in the case of this example, the evaluation value A2 with respect to the “animation” and the “specialized for children” becomes 0 points in the evaluation item of the “degree of topic of interest” and 10 points in the evaluation item of the “degree of effectiveness”.

The analysis section 61-3 sets, as the evaluation value A3, the value corresponding to “18:00”, which is the broadcast start time, and “18:30”, which is the broadcast end time, in the program introduction information of the program P1 supplied from the obtaining section 51.

The evaluation value A3 obtained by the analysis section 61-3 is used for the evaluation in the evaluation items of the “degree of easiness of viewing” and the “degree of specialization for adults”. Therefore, the analysis section 61-3 defines an evaluation value for each of those evaluation items.

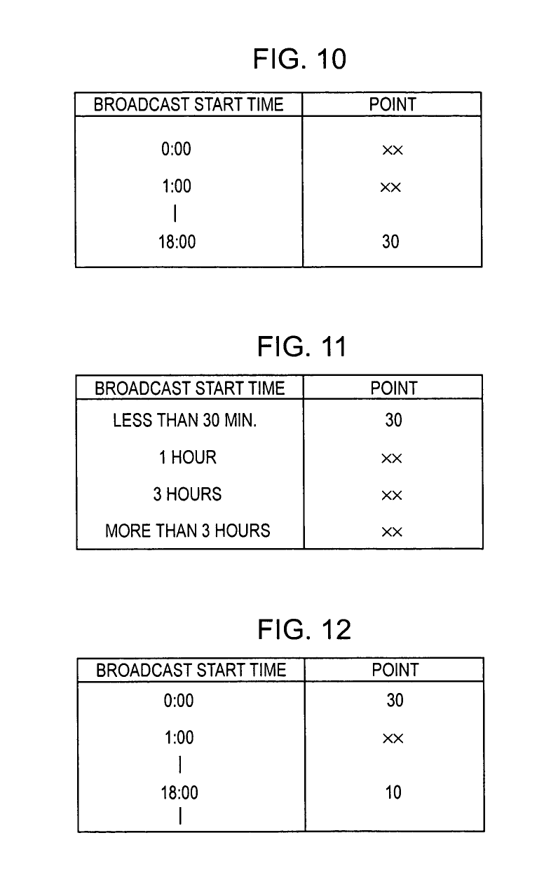

For example, with respect to the “degree of easiness of viewing”, the evaluation value A3 can be determined by using a table, shown in FIG. 10, in which points corresponding to broadcast start times are indicated, or a table, shown in FIG. 11, in which points corresponding to broadcast times are indicated.

With respect to the “degree of specialization for adults”, the evaluation value A3 can be determined by using a table, shown in FIG. 12, in which points corresponding to broadcast start times are indicated.

As a result, in the case of this example, the evaluation value A3 with respect to the broadcast start time (18:00) and the broadcast end time (18:30) becomes 30 points (FIGS. 10 and 11) in the evaluation item of the “degree of easiness of viewing” and 10 points (FIG. 12) in the evaluation item of the “degree of specialization for adults”.

Here, the evaluation value A3 is determined from the “broadcast start time” and the “end time” in the program introduction information. Alternatively, a wording related to the broadcast time, such as the “golden time” and the “long time”, can be extracted, so that the evaluation value A3 can be determined from the wording. More specifically, a thesaurus database for wordings related to the broadcast times is provided, a numerical value corresponding to the wording related to the broadcast time, the wording being extracted from the thesaurus database, is detected, and the numerical value is set as the evaluation value A3.

The analysis section 61-4 adds up “3”, which is the number of impressions of the program P1, and “1”, which is the number of comments thereof, which are supplied from the obtaining section 51, and sets 20 points, which is the value corresponding to the number (4) obtained thereby, as the evaluation value A4.

The analysis section 61-5 sets, as the evaluation value A5, 0 points corresponding to “0”, which is the number of reuse of the program introduction information of the program P1, which is supplied from the obtaining section 51.

The analysis section 61-6 sets, as the evaluation value A6, 10 points corresponding to “10%”, which is the audience rating of the program P1 and “no use”, which is the usage history, which are supplied from the obtaining section 51.

The analysis section 61-7 sets 10 points corresponding to “Nintama Rantaro”, which is the performer of the program P1, as the evaluation value A7.

The evaluation values A obtained by the analysis sections 61-1 to 61-7 in the manner described above are supplied to the evaluation section 53.

The evaluation section 53 evaluates the program P1 with respect to six evaluation items on the basis of the evaluation values A1 to A7 supplied from the analysis sections 61-1 to 61-7, respectively. In the case of this example, the “degree of topic of interest” is set at the second level, the “degree of easiness of viewing” is set at the fourth level, the “degree of effectiveness” is set at the third level, the “degree of devotion” is set at the second level, the “degree of specialization for adults” is set at the first level, and the “degree of casting” is set at the first level.

The evaluation results in the evaluation section 53 are supplied to the visualization section 54.

The visualization section 54 converts the evaluation results obtained from the evaluation section 53 into graphic representation, as shown in FIGS. 7 and 8, and displays them on the display section 17.

In the foregoing description, the visualization section 54 collectively converts each evaluation result of one program into graphic representation and presents it. Alternatively, evaluation results of a plurality of programs can also be stored, and the evaluation results of a plurality of programs are also displayed with respect to predetermined evaluation items.

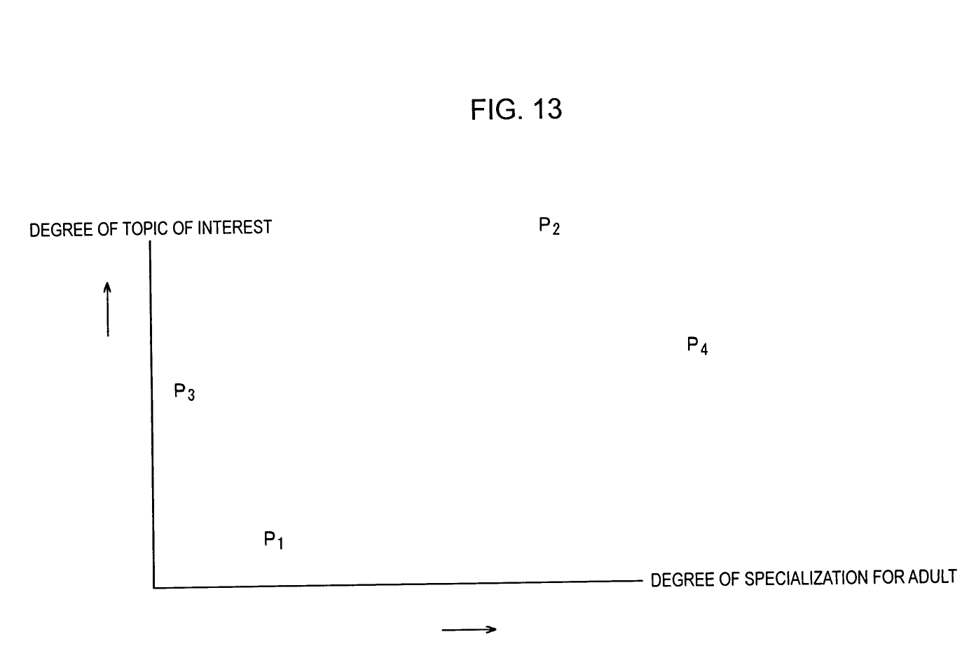

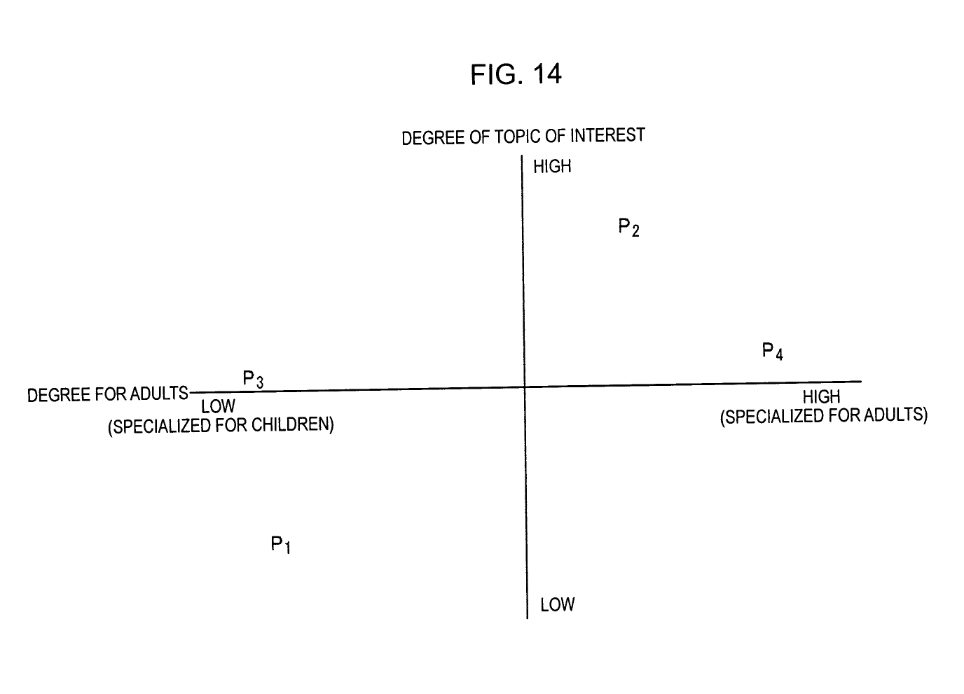

In the examples of FIGS. 13 and 14, the evaluation results of the “degree of topic of interest” and the “degree of specialization for adults” of the programs P1 to P4 are converted into graphic representation.

As described above, if the evaluation results with respect to the plurality of programs are collectively converted into graphic representation, it is possible for the user to easily compare programs with respect to the item. In consequence, program selection can be performed more efficiently.

The evaluation of the program is not limited to the combination of the above-described evaluation values A, and a new evaluation can be performed on the basis of another combination. For example, an evaluation can also be performed on the basis of the combination of the evaluation value A2 and the evaluation value A4.

In the foregoing description, an evaluation result with respect to a program for one broadcast is shown. Alternatively, for example, the evaluation results of predetermined evaluation items can also be displayed in a time series with respect to a program in series.

For example, in the case where a program (cuisine program) that is broadcast every week is to be evaluated on the basis of the combination of the evaluation value A2 and the evaluation value A4, when the evaluation values A2 and A4 shown in FIG. 15 are obtained and the evaluation results are obtained as shown in FIG. 15, a chart shown in FIG. 16 can be presented to the user.

In this specification, the steps describing a program recorded on a recording medium include not only processing which is carried out chronologically in the written order but also processing which is executed concurrently or individually although it is not necessarily processed chronologically.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing apparatus comprising:
obtaining means for obtaining program information of a program;
number conversion means for converting the program information into a numerical value;
evaluation means for evaluating the program based on the numerical value obtained by the number conversion by the number conversion means;
graphic representation means for collectively converting the evaluation results by the evaluation means into graphical representation; and
presentation means for presenting the evaluation results that are graphically represented by the graphic representation means.

2. The information processing apparatus according to claim 1, wherein the program information contains predetermined elements,
the number conversion means performs numerical conversion for each of the elements, and
the evaluation means evaluates the program on the basis of the numerical value of the predetermined element, which is obtained as a result of the number conversion by the number conversion means.

3. The information processing apparatus according to claim 2, wherein the obtaining means obtains the audience rating of a predetermined program, a program description, a keyword, information about a broadcast time, information about a performer of the program, impressions of programs that are sent to the program introduction site and the number of the impressions, the number of reuse of program introduction information, the number of comments that are sent to the official site of the program, and the usage history of the program of a predetermined terminal, and
the number conversion means sets the program description and the impressions sent to the program introduction site as a first element; sets the keyword as a second element; sets the information about the broadcast time as a third element; sets the number of impressions of the program, which are sent to the program introduction site and the number of comments sent to the program official site, as a fourth element; sets the number of reuse of the program introduction information as a fifth element; sets the audience rating and the usage history as a sixth element; and sets the information about the performer of the program as a seventh element, and performs number conversion for each of the first to seventh elements.

4. The information processing apparatus according to claim 3, wherein the evaluation means computes the evaluation value of the program based on the numerical values of the first, second, fourth, fifth, and sixth elements; on the basis of the numerical value of the third element; on the basis of the numerical values of the first and second elements; based on the numerical value of the first element based on the numerical values of the first and third elements; and based on the numerical value of the sixth element.

5. The information processing apparatus according to claim 1, wherein the program is a program that is broadcast in series,
the number conversion means converts each piece of the program information of the program that is broadcast in series into a numerical value,
the evaluation means evaluates each of the programs broadcast in series on the basis of the numerical value obtained by the number conversion by the number conversion means, and
the graphic representation means arranges the evaluation values obtained as a result of the evaluation by the evaluation means in a time series so as to convert the evaluation results into graphic representation.

6. An information processing method comprising:
obtaining program information of a program;
converting the program information into a numerical value;
evaluating the program based on the numerical value obtained by the number conversion;
collectively converting the evaluation results into graphic representation; and
presenting the evaluation results that are graphically represented.

7. A computer program comprising:
obtaining program information of a program;
converting the program information into a numerical value;
evaluating the program based on the numerical value obtained by the number conversion;
collectively converting the evaluation results into graphic representation; and
presenting the evaluation results that are graphically represented.

8. An information processing apparatus comprising:
an obtaining section obtaining program information of a program;
a number conversion section converting the program information into a numerical value;
an evaluation section evaluating the program based on the numerical value obtained by the number conversion by the number conversion section;
a graphic representation section collectively converting the evaluation results by the evaluation section into graphical representation; and
a presentation section presenting the evaluation results that are graphically represented by the graphic representation section.
